(19) United States
(12) Patent Application Publication
(10) Pub. No.: US 2025/0036706 A1
(43) Pub. Date: Jan. 30, 2025

(54) FACILITATING CHANGES TO ONLINE COMPUTING ENVIRONMENT BY EXTRAPOLATING INTERACTION DATA USING MIXED GRANULARITY MODEL

(71) Applicant: Adobe Inc., San Jose, CA (US)

(72) Inventors: Yuan Yuan, Sunnyvale, CA (US); Bei Huang, Mountain View, CA (US); Lijing Wang, Menlo Park, CA (US); Yancheng Li, Santa Clara, CA (US); Bowen Wang, Milpitas, CA (US); Jin Xu, Sunnyvale, CA (US); Zhenyu Yan, Cupertino, CA (US); Qilong Yuan, San Jose, CA (US)

(21) Appl. No.: 18/226,079

(22) Filed: Jul. 25, 2023

(51) Int. Cl. G06F 16/957; G06F 9/451; H04L 67/50

(52) U.S. Cl. CPC G06F 16/9577; G06F 9/451; H04L 67/535

(57) ABSTRACT

In some embodiments, a computing system extrapolates aggregated interaction data associated with users of an online platform by applying a mixed granularity model to generate extrapolated interaction data for each user in the users. The aggregated interaction data includes a total number of occurrences of a target action performed by the users with respect to the online platform. The extrapolated data includes a series of actions leading to the target action for each user. The computing system identifies an impact of each action in the series of actions for each user on leading to the target action based, at least in part, upon the extrapolating a series of actions associated with the user. User interfaces presented on the online platform can be modified based on at least the identified impacts to improve customization of the user interfaces to the users or enhance an experience of the users.

### TECHNICAL FIELD

This disclosure relates generally to facilitating modifications to interactive computing environments based on evaluating the performance of these environments. More specifically, but not by way of limitation, this disclosure relates to evaluating an interactive computing environment based on interaction data associated with the computing environment that are extrapolated when not available, and, in some cases, performing modifications to the evaluated interactive computing environment.

### BACKGROUND

Interactive computing environments, such as web-based applications or other online software platforms, allow users to perform various computer-implemented functions through graphical interfaces. A given interactive environment includes different graphical interfaces, each of which has a particular arrangement of available functionality or content. For instance, the interactive computing environment could present on a user device interface elements that search databases for different content items, interface elements that select the content items by storing them in a temporary memory location, or interface elements that cause a server to perform one or more operations on the combination of content items (e.g., creating a layered image, initiating a transaction to obtain a set of products, etc.).

It can be useful to understand the effectiveness of the graphical interfaces in helping users in reaching desirable outcomes via the application or online service. For example, it can be helpful to determine the impact of each operation in a series operations performed by a user on reaching the final goal thereby determining the effectiveness of the graphical interfaces associated with the individual operations. However, data about the individual operations for a user is not always available. As a result, existing methods evaluate aggregated impact of the series operations leading to an incomplete evaluation of the performance of the computing environments.

### SUMMARY

Certain embodiments involve applying machine learning models to interaction data for evaluating and thereby enabling modification of user interfaces for interacting with online platforms, such as electronic content delivery platforms. In one example, an impact identification system obtains aggregated interaction data associated with users of an online platform and the aggregated interaction data include a total number of occurrences of a target action performed by the users with respect to the online platform. The impact identification system extrapolates the aggregated interaction data by applying a mixed granularity model to generate extrapolated interaction data for each user. The extrapolated interaction data includes a series of actions leading to the target action for the user. Based on the extrapolated series of actions, the impact identification system identifies the impact of each action in the series of actions for each user on leading to the target action. Based on the identified impacts, the user interfaces presented on the online platform can be modified to improve the user experience.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which an online experience evaluation system can be used to extrapolate aggregated interaction data to facilitate modifications to an online platform, according to certain embodiments of the present disclosure.

FIG. 2 depicts an example of a process for facilitating the modification of an online platform based on aggregated interaction data extrapolated using a mixed granularity model, according to certain embodiments of the present disclosure.

FIG. 3 depicts an example of aggregated interaction data used by an online experience evaluation system to facilitate modifications to an online platform, according to certain embodiments of the present disclosure.

FIG. 4 depicts an example of extrapolated interaction data generated by applying a mixed granularity model to extrapolate aggregated interaction data for improving the user experience, according to certain embodiments of the present disclosure.

FIG. 5 depicts an example of a process for applying a mixed granularity model to generate extrapolated interaction data using aggregated interaction data as an input according to certain embodiments of the present disclosure.

FIG. 6 depicts an example of a computing system for implementing certain embodiments of the present disclosure.

### DETAILED DESCRIPTION

Certain embodiments involve extrapolating interaction data using a mixed granularity model to generate interaction data for evaluating user experiences with respect to an online platform, which can facilitate modifying one or more user interfaces provided by the online platform. For instance, an online evaluation system measures or estimates the performance of online platforms (e.g., the user experience of a user) by determining the impacts of individual actions performed by the user that led to a target action. However, the individual actions may not be available in the data provided by the online platform. As such, the online evaluation system is configured to extrapolate aggregated interaction data provided by the online platform to generated extrapolated interaction data. To do so, the online experience evaluation system applies a mixed granularity model to extrapolate the aggregated interaction data thereby generating data indicating a series of actions performed by each user associated with the online platform that led to the target action. The extrapolated interaction data are used to determine the impact of each action on reaching the target action, such as using an attribution model. The online experience evaluation system transmits the determined impacts to the online platform or another computing system which can use the determined impacts of individual actions to modify a user interface of an interactive computing environment provided by the online platform.

The following non-limiting example is provided to introduce certain embodiments. In this example, an online evaluation system, which is in communication with an online platform, executes one or more modeling algorithms that allow for enhancing interactive user experiences at the online platform. To do so, the online evaluation system accesses aggregated interaction data from the online platform. The aggregated interaction data is generated by recording and aggregating interactions that occur when user devices use one or more interfaces provided by the online platform. The interaction data is aggregated because of reasons such as privacy. For example, the aggregated interaction data may include the total number of occurrences of the target action performed by multiple users with respect to the online platform (e.g., the total number of transactions performed on a retailer website). In this way, the aggregated interaction data do not reveal details of individual users.

However, individual actions leading to the target action are useful in analyzing the performance of the online platform. As such, the online evaluation system applies a mixed granularity model to the aggregated interaction data to generate or reconstruct the series of actions (also referred to as a “user path”) that led to the target action. The target action can represent a higher level of user engagement in the online platform than mere viewing the content or clicking on links of the online platform. Examples of the target action can include posting comments on a website hosted by the online platform, uploading images or videos on the online platform, or performing a transaction on the online platform. The mixed granularity model can generate or reconstruct the series of actions by determining a terminal action of the series of actions and assigning one or more additional actions to the series of actions based on the terminal action. The terminal action can represent a penultimate action in the series of actions having the target action as the last action in the series of actions. Determining the terminal action can involve using a set of distributed occurrences determined using the aggregated interaction data. The time period over which the interaction data was aggregated can be divided into one or more time points such that the total number of occurrences can be distributed across the time points of the time period. Each occurrence of the target action can be distributed over the time period to generate the set of distributed occurrences. Based on the distributed target action, the mixed granularity model extrapolates each action back in time to generate the series of actions leading to the action for each user

The online evaluation system further determines, based on the extrapolated interaction data, the impact or contribution of each action in the series of actions in reaching the target action. For example, the online evaluation system can apply an attribution model to the extrapolated series of actions to determine the impact. The online evaluation system transmits or otherwise provides the identified action impacts to one or more computing systems that are used to host or configure the online platform. In some embodiments, providing the identified action impacts to systems that host online platforms can allow various user interfaces of the interactive computing environment to be customized to particular users, modified to enhance the experience of certain types of users, or some combination thereof.

As described herein, certain embodiments provide improvements to interactive computing environments by solving problems that are specific to online platforms. These improvements include more effectively configuring the functionality of an interactive computing environment based on accurate and precise evaluations of performance of the interactive computing environment, such as the user experience within the interactive computing environment. Facilitating these performance-based modifications involves identifying, from aggregated interaction data, a series of actions that lead to a target action for the user with respect to an interactive computing environment. This is particularly difficult in that the actions of users of the interactive computing environment may be constantly changing depending on the content the user is viewing or the operations the user is performing or has performed. These ephemeral, rapidly transitioning stages makes it uniquely difficult to evaluate the user experience within an interactive computing environment.

Because these problems are specific to computing environments, embodiments described herein utilize a mixed granularity model and other automated models (e.g., attribution AI model) that are uniquely suited for assessing computing environments. For instance, a computing system automatically applies various rules of a particular type to aggregated interaction data (e.g., various functions employed in one or more models, rules used to extrapolate the user actions) and thereby computes objective measurements of performance of the computing environment (e.g., the impact of the individual actions in user paths), sometimes in a real-time or near real-time manner. The objective measurements are usable for enhancing a computing environment by, for example, modifying interface elements or other interactive aspects of the environment. Using one or more models described herein can therefore allow for a more accurate and precise evaluation of what type of content are more likely to enhance the user experience with the online platform. Consequently, certain embodiments more effectively facilitate modifications to a computing environment that facilitate desired functionality, as compared to existing systems.

As used herein, the term “online platform” is used to refer to an interactive computing environment, hosted by one or more servers, that includes various interface elements with which user devices interact. For example, clicking, tapping or otherwise interacting with one or more interface elements during a session causes the online platform to manipulate electronic content, query electronic content, or otherwise interact with electronic content that is accessible via the online platform.

As used herein, the term “interaction data” is used to refer to data generated by one or more user devices interacting with an online platform that describes how the user devices interact with the online platform. For example, the interaction data for an interaction can include a description of the interactions, using, for example, an identifier of the user involved in the interaction, the type of interactions (viewing, clicking, or conversion), the date and time of the interaction, the content involved in the interaction, and so on.

As used herein, the term “aggregated interaction data” is used to refer to the interaction data that are combined in a certain manner to avoid revealing detailed information regarding users, timing and actions. For example, the aggregated interaction data may describe a total number of occurrences of a target action performed by a group of users within a time period without including the series of actions that led to the target action. As a result, the aggregated interaction data does not include the detailed information of individual users, information of the individual actions and the timing information of the actions.

As used herein, the term “action” is used to refer to an operation performed by a user on the online platform. An action can include, for example, visiting a webpage A, or, in more detail, viewing a webpage, clicking on a link on a webpage, performing a search on a webpage, entering data on a webpage, and so on.

As used herein, the term “target action” is used to refer to an action performed by a user that achieves a certain goal. For example, the target action can represent an action performed by the user such as posting comments on a website hosted by the online platform, uploading images or videos on the online platform, or performing a transaction on the online platform. A target action normally involves actions more than mere viewing the content or clicking on links of the online platform.

As used herein, the term “terminal action” is used to refer to an action performed by the user just before the user performs the target action. In other words, in a series of actions where the target action is a final action, the terminal action can represent a penultimate action performed by the user prior to the target action. For example, prior to performing a target action of posting a comment to a website hosted by the online platform, the user may perform a terminal action of generating the comment by typing into a text box provided by the website.

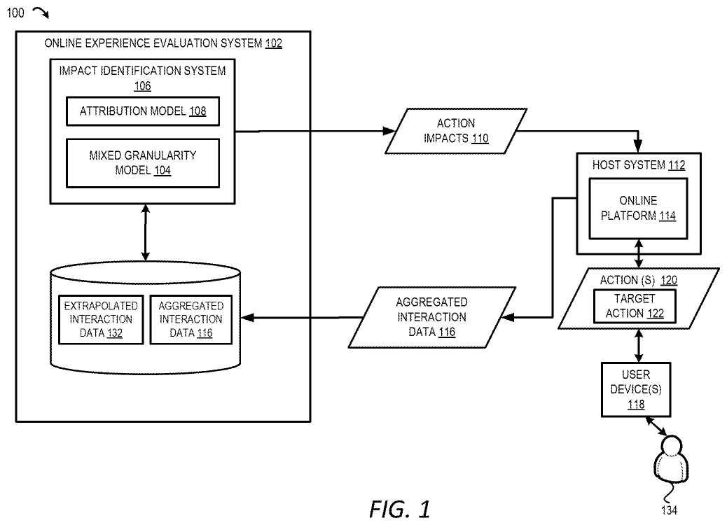

Referring now to the drawings, FIG. 1 depicts an example of computing environment 100 in which an online experience evaluation system 102 evaluates and, in some cases, facilitates modifications to user interfaces in an online platform 114 provided by a host system 112. In various embodiments, the computing environment 100 includes one or more of the online experience evaluation system 102 and the host system 112. The online experience evaluation system 102 can be configured to apply a mixed granularity model 104 to aggregated interaction data 116 to generate extrapolated interaction data 132 for one or more users 134 with respect to the online platform 114. The aggregated interaction data 116 can be generated by recording interactions between the online platform 114 and user devices 118 associated with the users 134. The mixed granularity model 104 can take the aggregated interaction data 116 as an input to generate the extrapolated interaction data 132 that can include a series of actions leading to a target action for the users 134. As described above, the target action can include an action performed by the users 134 to achieve a particular goal. The online experience evaluation system 102 can further apply the attribution model 108 to identify an action impact 110 of each action 120 for the user 134 with respect to leading to the target action 122. Examples of the action 120 performed by the users 134 can include clicking a link, viewing a webpage, signing up for a subscription, accessing a communication or message, submitting a feedback survey, and so on.

The online experience evaluation system 102 provides the action impact 110 of each action 120 to the host system 112. In some embodiments, providing the action impact 110 to the host system 112 causes one or more features of the online platform 114, such as the user interfaces, to be changed such that subsequent interactive user experiences are enhanced for the users 134. For example, the online experience evaluation system 102 receives or obtains aggregated interaction data 116 associated with the users 134 of the online platform 114. The aggregated interaction data 116 can be generated by a user device 118 of each user 134 that interacts with the online platform 114. The aggregated interaction data 116 describes how the user device 118 interacted with the online platform 114. In some embodiments, the aggregated interaction data 116 can include contextual features associated with the target action 122. Examples of contextual features include, but are not limited to, the date and time period of the target action 122, a type of the target action 122, special features involved in performing the target action 122, and so on.

In some embodiments, the host system 112 could include one or more servers that log user activity in the online platform 114 and transmit, to the online experience evaluation system 102, the aggregated interaction data 116 describing the logged activity. In additional or alternative embodiments, a user device 118 could execute one or more services (e.g., a background application) that log user activities in the online platform 114 and transmit, to the online experience evaluation system 102, the aggregated interaction data 116 describing the logged activities.

In these various embodiments, logging the user activity includes, for example, creating records that identify a user entity (e.g., the user device 118 or a credential used to access the online platform 114), timestamps for various interactions that occur over one or more sessions with the online platform 114, a duration of the interactions, a status of the online platform 114 or website at the time of the interaction, and identifiers that characterize the interaction. Examples of identifiers include an identifier of the webpage that was visited (e.g., a uniform resource locator (URL)), an identifier of a particular interface element that was clicked or otherwise used, and so on.

Instead of providing granularity with respect to the user activity, the aggregated interaction data 116 may describe aggregated interactions that can occur when the user device 118 interacts with one or more user interfaces of the online platform 114. For example, if more than one user device 118 interacts with a particular user interface provided by the online platform 114, the aggregated interaction data 116 may describe a total number of interactions performed by multiple users with respect to the particular user interface of the online platform 114. The aggregated interaction data 116 can obscure individual user activity, such as due to privacy concerns or because of limited storage space.

In some embodiments, the online experience evaluation system 102 extrapolates the aggregated interaction data 116 to generate extrapolated interaction data 132 for each user 134. The aggregated interaction data 116 can include a total volume of actions performed by the users 134 over a time period (e.g., hours, days, weeks, months, etc.). Additionally, the aggregated interaction data 116 can include a total number of occurrences of the target action performed by the users 135 over the time period. The online experience evaluation system 102 can employ a mixed granularity model 104 to extrapolate the aggregated interaction data 116. To do so, the online experience evaluation system 102 can pre-process the aggregated interaction data 116 associated with the users 134 and distribute the total number of occurrences of the target action described by the aggregated interaction data 116. Pre-processing the aggregated interaction data 116 can include estimating a ratio used to map a reported population of the users 134 to a modeled population of the users 134. The modeled population can be a subset of the reported population such that the ratio is less than or equal to one. The ratio can be used to determine a total number of the actions to distribute over a time period associated with the aggregated interaction data 116. For example, a total volume of actions included in the aggregated interaction data 116 can be multiplied by the ratio to determine the total number of the actions to distribute.

Distributing the total number of occurrences of the target action can involve allocating a subset of the total number of occurrences to one or more time points of the time period. For instance, if the total number of occurrences is 50 over a time period of five days, the total number of occurrences may be distributed evenly such that a respective time point corresponding to each day of the five days is assigned 10 occurrences of the target action. Once distributed among the time points of the time period, a respective number of occurrences assigned to each time point may be an integer, fraction, or decimal. In additional or alternative embodiments, the total number of occurrences may be distributed to an ending time point instead of being evenly distributed across multiple time points of the time period. For instance, the total number of occurrences may all be assigned to the fifth day of the time period such that the first day through the fourth day of the time period each are assigned zero occurrences and that the fifth day is assigned 50 occurrences of the target action. Based on the total number of actions and the distributed number of occurrences, the online experience evaluation system 102 employs the mixed granularity model 104 to generate the extrapolated interaction data 132 for each user 134. For example, the online experience evaluation system 102 can provide the aggregated interaction data 116 to the mixed granularity model 104 as input and obtain the extrapolated interaction data 132 generated by the mixed granularity model 104. The extrapolated interaction data 132 can indicate a series of actions performed by each user 134 that leads to the target action 122. The mixed granularity model 104 can use the total number of actions and the distributed number of occurrences to organize the individual actions into the series of actions performed by each user 134. In examples in which a subset of the users 134 did not perform the target action 122, the mixed granularity model 104 may distribute the individual actions based on the number of the users 134.

In addition to the mixed granularity model 104, the online experience evaluation system 102 can further employ an attribution model 108 to identify an impact 110 of each action 120 in the series of actions on resulting in the target action being performed by the user. For instance, the impact 110 of each action 120 can correspond to a probability or propensity of the user 134 performing the target action 122 due to, at least in part, the action 120. The probability or propensity is also referred to as the conversion probability or propensity. A higher probability or propensity of performing the target action 122 indicates that the user 134 is at a higher level of engagement, and vice versa. Accordingly, the user 134 performing the target action 122 can indicate that the user 134 is at a higher level of engagement than passively engaging with (e.g., simply viewing or browsing) the online platform 114. In some implementations, the attribution model 108 can estimate the conversion probability or propensity of the user by applying a recursive neural network (RNN), such as a long short-term memory (LSTM) network, on the series of actions.

The online experience evaluation system 102 may transmit the impact associated with the series of actions for each user to the host system 112. In some embodiments, doing so causes the host system 112 to modify user interfaces or other properties of the online platform 114 based on the impact of the series of actions or a respective impact of particular actions of the series of actions. In one example, an online platform 114 could rearrange the layout of an interface so that features or content associated with relatively higher impact are presented more prominently, features or content associated with relatively lower impact are presented less prominently, or some combination thereof. In various embodiments, the online platform 114 performs these modifications automatically based on an analysis of the impact 110 of the actions 120 of the user 134.

In some embodiments, modifying one or more interface elements is performed in real time, i.e., during a session between the online platform 114 and a user device 118. For instance, an online platform 114 may be modified based on an interaction between the user device 118 and the online platform 114. If, during a session, an action 120 with relatively higher impact (e.g., promotes the users 134 transitioning to a higher stage of user engagement) is identified, the online platform 114 could be modified to include the content involved in the action 120 in an effort to improve the user experience. The online experience evaluation system 102 can continue to evaluate the online experience during the session and thereby determine if additional changes to the interactive computing environment are warranted. In other embodiments, the interactive computing environment is modified after a given session is complete and the action impact 110 of the actions 120 for the session are transmitted to the host system 112.

One or more computing devices are used to implement the online experience evaluation system 102 and the host system 112. For instance, the online experience evaluation system 102, the host system 112, or both could include a single computing device, a group of servers or other computing devices arranged in a distributed computing architecture, etc.

The online platform 114 can be any suitable online service for interactions with the user device 118. Examples of an online platform include a content creation service, an electronic service for entering into transactions (e.g., searching for and purchasing products for sale), a query system, etc. In some embodiments, one or more host systems 112 are third-party systems that operate independently of the online experience evaluation system 102 (e.g., being operated by different entities, accessible via different network domains, etc.). In additional or alternative embodiments, one or more host systems 112 include an online experience evaluation system 102 as part of a common computing system. The user device 118 may be any device that is capable of accessing an online service. For non-limiting examples, user device 118 may be a smartphone, smart wearable, laptop computer, desktop computer, tablet, or other type of user device.

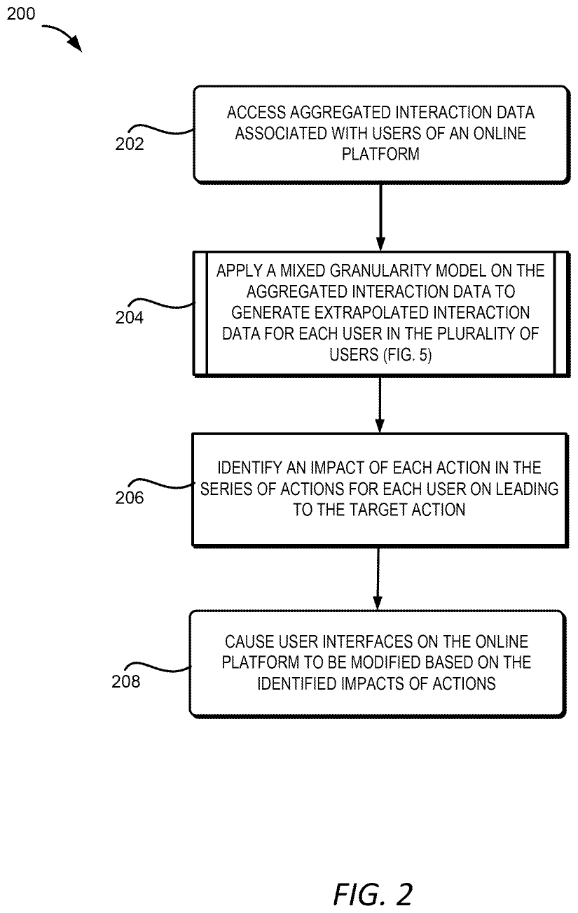

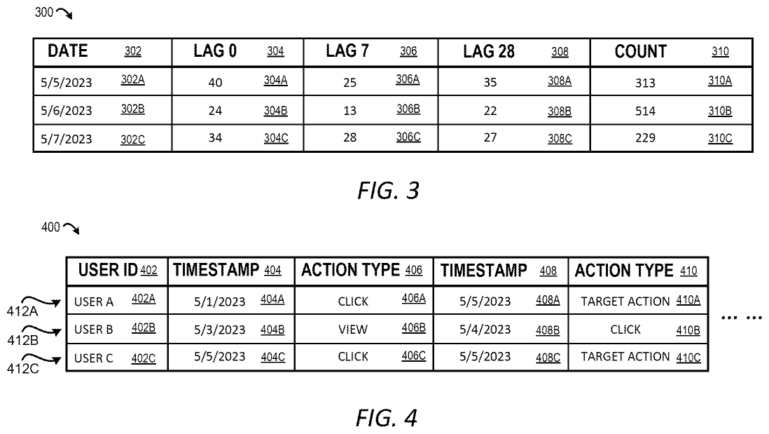

FIG. 2 depicts an example of a process 200 for facilitating the modification of an online platform 114 based on aggregated interaction data 116 extrapolated using a mixed granularity model 104, according to certain embodiments of the present disclosure. One or more computing devices (e.g., the online experience evaluation system 102) implement operations depicted in FIG. 2 by executing suitable program code. For illustrative purposes, the process 200 is described with reference to certain examples depicted in the figures. Other implementations, however, are possible. FIG. 2 will be described in conjunction with FIGS. 3 and 4.

At block 202, the process 200 involves obtaining aggregated interaction data 116 associated with one or more users 134 of an online platform 114. For instance, interactions between user devices 118 associated with the users 134 and the online platform 114 may create interaction data that is then aggregated to generate the aggregated interaction data 116. The aggregated interaction data 116 can include a total number of occurrences of a target action 122 performed by the users 134 with respect to the online platform 114. Examples of the target action 122 can include completing a transaction, registering for a membership, downloading software, and so on. FIG. 3 depicts an example 300 of aggregated interaction data 116 used by the online experience evaluation system 102 to facilitate modifications to the online platform 114. Although the aggregated interaction data 116 is depicted as a table in FIG. 3, it should be recognized that other formats (e.g., a spreadsheet, chart, text file, etc.) for providing the aggregated interaction data 116 are possible.

The aggregated interaction data 116 can include a date column 302 with one or more dates 302A-C that can correspond to a date or time that a target action was performed. In addition, FIG. 3 includes several columns for different time intervals preceding the date shown in column 302. For each column, the number in the table shows the count of terminal actions performed during the corresponding time interval that led to the target action observed on the date shown in column 302. For instance, FIG. 3 depicts a “lag 0” interval column 304, a “lag 7” interval column 306, and a “lag 28” interval column 308. In this example, “lag 0” refers to the time interval of 0 to 24 hours before the date shown in column 302; “lag 7” refers to the time interval of one to seven days before the date shown in column 302; “lag 28” refers to the time interval of 8 days to 28 days prior to the date shown in column 302. Data entry 304A provides the number of target actions observed on the date 302A (i.e., May 5, 2023) that were caused by terminal actions performed during lag 0. In other words, 40 of the target actions observed on May 5, 2023 were caused by terminal actions performed within 24 hours before May 5, 2023. Similarly, data entry 306A indicates that 25 target actions observed on May 5, 2023 were caused by terminal actions performed one to seven days before May 5, 2023, and data entry 308A indicates that 35 target actions observed on May 5, 2023 were caused by terminal actions performed 8 to 28 days before May 5, 2023. The second and third rows of table 300 indicate similar information on May 6, 2023 and May 7, 2023. In other implementations, the particular time interval may have a scale of hours, weeks, months, or another suitable timeframe.

Additionally, FIG. 3 depicts a “count” column 310 to provide a total number of actions (e.g., the actions 120 of FIG. 1) performed on a corresponding date listed in the date column 302. Data entry 310A provides the total number of actions performed on the date 302A (i.e., May 5, 2023). Data entries 310B-C provide similar information on May 6, 2023 and May 7, 2023, respectively. In some cases, the total number of actions provided in the “count” column 310 may correspond to a specific type of action (e.g., click, view, impression, etc.).

Returning to FIG. 2, the online experience evaluation system 102 accesses the aggregated interaction data 116 from a suitable non-transitory computer-readable medium or other memory device. In some embodiments, the aggregated interaction data 116 is stored on one or more non-transitory computer-readable media within the host system 112. The online experience evaluation system 102 accesses the aggregated interaction data 116 via suitable communications with a host system 112 (e.g., a push or batch transmission from the host system 112, a pull operation from the online experience evaluation system 102, etc.). In additional or alternative embodiments, the online experience evaluation system 102 and the host system 112 are communicatively coupled to a common data store (e.g., a set of non-transitory computer-readable media, a storage area network, etc.). The online experience evaluation system 102 retrieves the aggregated interaction data 116 from the data store after the host system 112 stores the aggregated interaction data 116 in the data store. In additional or alternative embodiments, aggregated interaction data 116 is stored at user devices 118 and transmitted to the online experience evaluation system 102 directly, without involving the host system 112. For instance, a background application on each user device 118 could transmit a set of aggregated interaction data 116 for that user device 118 to the online experience evaluation system 102.

At block 204, the process 200 involves extrapolating the aggregated interaction data 116 by applying a mixed granularity model 104 to generate extrapolated interaction data 132 for each user 134. The online experience evaluation system 102 can employ the mixed granularity model 104 to generate the extrapolated interaction data 132 that includes a series of actions leading to a target action 122 for each user 134. The target action 122 can represent a higher level of user engagement in the online platform 114 than browsing content of the online platform 114. For instance, the user 134 may perform the target action 122 by posting a review or providing feedback through a website hosted by the online platform 114.

In some examples, the online experience evaluation system 102 can pre-process a total volume of actions 120 included in the aggregated interaction data 116 associated with the users 134 to generate a total number of actions 120 to distribute across a time period associated with the aggregated interaction data 116. For example, the total volume of actions 120 may be provided in the aggregated interaction data 116 as an integer corresponding to a specific date or time of when the actions 120 were performed. The time period can represent a time difference between when an action 120 is performed and when a target action 122 occurs. In some embodiments, the time period can also be referred to as a lag as discussed above with respect to FIG. 3. The online experience evaluation system 102 can pre-process the total volume of actions 120 by multiplying the total volume of actions 120 by a ratio that correlates a reported population of the users 134 to a modeled population of the users 134. The reported population can correspond to a total number of users 134 associated with the online platform 114. The modeled population can correspond to a subset of the reported population that is identifiable using an identifier (e.g., a user ID). Multiplying the total volume of actions 120 by the ratio can discount the total volume of actions 120 to correspond to the modeled population instead of the entire reported population. The aggregated interaction data 116 can be extrapolated based on a respective identifier of users 134 in the modeled population to generate the extrapolated interaction data 132 that provides more granularity with respect to the users 134 in comparison to the aggregated interaction data 116. This pre-processing of the total volume of actions 120 yields Equation 1 defined below:

$$dailyCount = ( ( Date , type ) , count \times ratio ) \qquad ( 1 )$$

where dailyCount is the total number of actions 120 to allocate over the time period, Date is a date corresponding to the total volume of actions 120, type is a type of action, count is the total volume of actions 120, and ratio is the ratio correlating the reported population of the users 134 to the modeled population. In some implementations, the type of action can be a click that corresponds to a user 134 clicking a link of the online platform 114. In additional or alternative implementations, the type of action can be an impression that indicates a number of opportunities for the users 134 to view or interact with the online platform 114. The ratio can be determined using existing insights associated with the online platform 114. In additional or alternative embodiments, the ratio can be determined using data from other channels that individual-level data (e.g., data corresponding to each user 134) in addition to the aggregated interaction data 116.

In addition to pre-processing the total volume of actions 120, the online experience evaluation system 102 further can distribute a total number of occurrences of the target action 122 across a time period associated with the target action 122 to generate a set of distributed occurrences. Specifically, the time period can be divided into one or more time points such that each occurrence of the total number of occurrences can be assigned to a respective time point. As an illustrative example, if a total of 25 occurrences are associated with a time period of 7 days as shown in FIG. 3, the occurrences can be distributed across 7 time points that each correspond to a respective day of the time period. In some implementations, the total number of occurrences is distributed evenly across the time points of the time period. For example, the total of 25 occurrences can be distributed over the 7 time points such that each time point is assigned 3 (i.e., approximately 25/7) occurrences. In additional or alternative implementations, the total number of occurrences can be assigned to an ending time point, for example such that the total of 25 occurrences are all assigned to the 7^{th} time point.

Distributing the total number of occurrences can be represented by Equation 2 below:

$$dateLagCount = ( ( convDate , lag , type ) , \# occurrences ) \qquad ( 2 )$$

where convDate is a date associated with an occurrence of the target action, lag is a time period representing a difference between when an action is performed and the occurrence of the target action, type is the type of the action, and: occurrences is the number of occurrences corresponding to the convDate. Aggregating the convDate can yield lagCount=((lag, type), #occurrences) where lagCount indicates a number of occurrences of the target action that correspond to a specific time period and type of action.

In some embodiments, the total number of occurrences is provided with respect to time intervals of the time period. The time intervals of the time period can be referred to as lags. For instance, for a time period of 28 days, the total number of occurrences may be provided over three lags that respectively correspond to the past 24 hours, the previous 1-7 days, and the previous 8-28 days. In the example shown in FIG. 3, a total of 100 occurrences may be provided as 40 occurrences associated with a first lag of the past 24 hours, 25 occurrences associated with a second lag of the previous 1-7 days, and 35 occurrences associated with a third lag of the previous 8-28 days. Accordingly, 40 occurrences can be assigned to a first time point corresponding to a first day of the 28 days, while each time point of the second lag can be assigned 25/7 (i.e., approximately 3.57) occurrences. The remaining 35 occurrences can be distributed evenly across 21 time points of the third lag such that each time point of the third lag is assigned 35/21 (i.e., approximately 1.67) occurrences.

Based on the total number of actions 120 and the set of distributed occurrences, the mixed granularity model 104 can assign each action 120 of the total number of actions 120 to generate a series of actions associated with each user 134 identified using an identifier. In some implementations, the mixed granularity model 104 can obtain individual-level data corresponding to each user 134 that can include a list of occurrences of the target action 122 associated with a respective user. The list of occurrences can be represented by Equation 3 defined below:

$$guidConvs = ( GUID , list ( convDate ) ) \qquad ( 3 )$$

where guidConvs is the list of occurrences for a particular user, GUID is the identifier of the particular user, and list (convDate) is a list of occurrences that can be aggregated based on the identifier of the particular user. The individual-level data additionally can include a dataset containing one or more dates and a corresponding number of occurrences of the target action 122 associated with each date of the one or more dates. For example, the dataset can be provided as a table with a column listing the one or more dates and another column listing the corresponding number of occurrences associated with each date of the one or more dates. The dataset can be represented by Equation 4 defined below:

$$dateConvs = ( Date , \# occurrences ) \qquad ( 4 )$$

where dateConvs is an aggregation of the individual-level data that indicates the total number of occurrences of the target action 122, Date is a date, and #occurrences represents the number of occurrences that corresponds to a respective date.

Using guidConvs of Equation 3, the mixed granularity model 104 can determine a probability P(L) of an identified user having an occurrence of the target action 122 corresponding to a lag L on a day D with a particular type of action. The probability can be determined using Equation 5 defined below:

$$P ( L ) = \frac{dateLagCount ( D , L , type )}{dateConvs ( D )} \qquad ( 5 )$$

where dateLagCount is described with respect to Equation 2 above and dateConvs is described with respect to Equation 4 above. Equation 5 can result in a multinomial distribution that is used to determine a corresponding lag of an action 120 by sampling a number from the multinomial distribution. Subsequently, a terminal action can be assigned to a generated date defined as a difference between the date D of the occurrence of the target action and the lag L. In this way, the generated date aligns with Equation 2. The terminal action can represent a particular action in a series of actions that is performed prior to the occurrence of the target action 122.

Once the terminal action is assigned to a generated date, the mixed granularity model 104 can assign one or more additional actions that occur prior to the terminal action, thereby generating the series of actions included in the extrapolated interaction data 132.

$$Assuming \frac{{t}_{i}}{{p}_{i}} = constant \times decay ( i ) ,$$

where tᵢ is the number of lag_{i,type} and pᵢ is the number of paths touched by lag_{i,type}, for time point i (e.g., the number of paths that has an additional action of type type i lags before the target action time point),

$${p}_{i} = {t}_{i} \times \frac{{p}_{0}}{{t}_{0}} \times \frac{decay ( 0 )}{decay ( i )} \qquad ( 6 )$$

tᵢ/t₀ and decay(i)/decay(0) are ratios that can be determined using other channels with access to individual-level data. When l₀=lagCount(0, type), p₀=l₀. By having the additional actions be generated by a corresponding terminal action,

$${p}_{i} = {t}_{i} \times \frac{{p}_{0}}{{t}_{0}} \times \frac{decay ( 0 )}{decay ( i )} = {l}_{i} + {\sum }_{j < i} {w}_{ij} \cdot {l}_{j} \qquad ( 7 )$$

where wᵢⱼ is the probability of a last lag j generating a previous lag i. Assuming wᵢⱼ=wᵢⱼ′=wᵢ, wᵢ can be determined as:

$${w}_{i} = \frac{( {t}_{i} \times \frac{{p}_{0}}{{t}_{0}} \times \frac{decay ( 0 )}{decay ( i )} - {l}_{i} )}{{\sum }_{j < i} {l}_{j}} \qquad ( 8 )$$

A probability P_{add} of the additional actions being determined with respect to the terminal action can be defined by P_{add}=wᵢ. With the determined wᵢ, the additional actions prior to the terminal action can be determined using Equation 7.

In some embodiments, a subset of the users 134 perform a series of actions that does not result in the target action. The series of actions that does not result in the target action can be referred to as a negative path. To assign actions to a negative path, a probability P_{neg}, as defined below in Equation 9, can be used:

$${P}_{neg} = \frac{dailyCou nt ( Date , type )}{\# GUID} \qquad ( 9 )$$

where dailyCount is described above with respect to Equation 1 and #GUID is the total number of identifiers associated with the users 134 interacting with the online platform 114.

FIG. 4 depicts an example 400 of extrapolated interaction data 132 generated by applying the mixed granularity model 104 to extrapolate aggregated interaction data 116 for improving the user experience. Aspects of FIG. 4 are described below with reference to components discussed above in relation to FIG. 1. Similar to FIG. 3, although the extrapolated interaction data 132 is depicted as a table in FIG. 4, it should be recognized that other formats (e.g., a spreadsheet, chart, text file, etc.) for providing the extrapolated interaction data 132 are possible. In FIG. 4, the extrapolated interaction data 132 can include one or more series of actions organized based on user identifiers 402A-C listed in column 402 of the example 400. The user identifiers 402A-C can correspond to one or more users 134 that interact with the online platform 114 to perform the actions 120.

The aggregated interaction data 116 provided as an input to the mixed granularity model 104 can be distributed to correspond to the user identifiers 402A-C. For instance, the extrapolated interaction data 132 of FIG. 4 can include actions 120 performed by the users 134 listed based an action type of each action in column 406 and column 410. A corresponding timestamp of each action 120 is included in column 404 for action types 406A-C of column 406 and in column 408 for action types 410A-C of column 410. Timestamps 404A-C and timestamps 408A-C can indicate a date on which the actions 120 were performed. As depicted in FIG. 4, the aggregated interaction data 116 can be used to generate a series of actions corresponding to each user 134 that can represent a virtual path taken by each user 134 when interacting with the online platform 114.

In some instances, the series of actions performed by the users 134 may end in a target action 122 being performed. As depicted in FIG. 4, a first row 412A can represent a first series of actions performed by user A associated with a first user identifier 402A. Click 406A performed at timestamp 404A of May 1, 2023 can be a first action performed by user A in the first series of actions displayed in the first row 412A. The first row 412A associated with the first user identifier 402A additionally includes target action 410A (e.g., a purchase, content upload, comment or review post, etc.) as a second action performed four days after click 406A at timestamp 408A of May 5, 2023. Target action 410A can indicate an end to this first series of actions performed by user A associated with the first user identifier 402A. Accordingly, click 406A can represent a terminal action performed by user A in the first series of actions before performing target action 410A. For instance, click 406A may be associated with user A clicking on an advertisement presented on a webpage hosted by the online platform 114 such that user A subscribes to a subscription associated with the advertisement as target action 410A.

Constructing the first series of actions can involve identifying that target action 410A is associated with user A, indicating that a positive path is associated with the first user identifier 402A. Based on user A being associated with a positive path and individual-level data, Equation 5 described above can be used to determine a probability of user A performing a terminal action associated with a specific type of action and a specific lag on a specific date. As an example, the individual-level data can be used to determine timestamp 408A of target action 410A being May 5, 2023. For a specific lag of the past four days from timestamp 408A corresponding to an action type of a click, timestamp 404A of click 406A can be determined. Accordingly, click 406A at timestamp 404A can be assigned to the first user identifier 402A as the terminal action for the first series of actions performed by user A.

Although FIG. 4 depicts the first series of actions as only including click 406A and target action 410A, it is appreciated that the first series of actions may include more than one action performed prior to target action 410A. In such examples, to complete the first series of actions after determining the terminal action, Equation 8 described above can be used to estimate a probability (e.g., wᵢ of Equation 8) of an action occurring prior to the terminal action. Completing the first series of actions may involve an iterative process of using Equation 8 to determine the probability of a preceding action occurring after assigning the terminal action to the first series of actions. For example, after the click 406A is assigned to the first user identifier 402A as the terminal action, Equation 8 may be used to determine that another action was performed prior to click 406A to result in target action 410A being performed.

In additional or alternative embodiments, a particular series of actions performed by the users 134 may result in a negative path such that a target action 122 is not performed. As an example, a second row 412B of FIG. 4 represents a second series of actions performed by user B associated with a second user identifier 402B. The second row 412B includes two actions: view 406B performed at timestamp 404B of May 3, 2023 and click 410B performed two days later at timestamp 408B of May 5, 2023. In contrast to the first series of actions performed by user A, the second series of actions lacks a target action 122 performed by user B. For instance, view 406B may correspond to user B viewing a webpage of the online platform 114 used to upload digital content (e.g., a video, photograph, review, digital art, etc.). Click 410B can correspond to user B interacting with a user interface element (e.g., a button, drop-down list, check box, etc.) provided on the webpage to begin uploading digital content to the online platform 114. But, instead of confirming the upload of the digital content to the online platform 114, user B may close the webpage of the online platform 114, resulting in a negative path that lacks a target action 122 of the digital content being uploaded.

Constructing the second series of actions corresponding to a negative path can involve identifying that user B is not associated with a target action 122. Subsequently, Equation 9 described above can be used to determine a probability of an action being associated with a particular user identifier. As an example, a total number of actions performed on May 3, 2023 by a total of three users (i.e., user A, user B, and user C) may be distributed among the three users such that one action is estimated to be performed by each user 134 associated with a negative path. Accordingly, based on this estimation for the negative path, the second series of actions associated with user B can be constructed.

In some implementations, the users 134 may perform the target action 122 during a same time period as another action in the series of actions. As an example, a third row 412C of FIG. 4 represents a third series of actions performed by user C associated with a third user identifier 402C, where click 406C and target action 410C are performed on the same day of May 5, 2023. In some examples, timestamp 404C and timestamp 408C may provide additional granularity with respect to an order of when click 406C and target action 410C were performed. For example, in addition to the date on which click 406C and target action 410C were performed, timestamp 404C and timestamp 408C can indicate a time of day corresponding to when click 406C and target action 410C were performed.

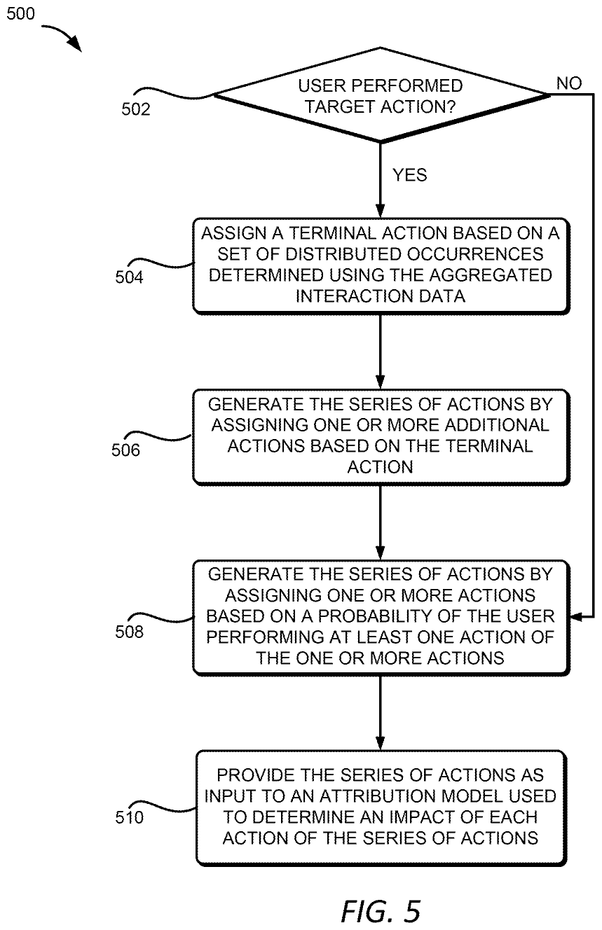

Referring back to FIG. 2, additional details about extrapolating the aggregated interaction data 116 by applying a mixed granularity model 104 to generate extrapolated interaction data 132 for each user 134 involved in block 204 are provided with respect to FIG. 5 below. Functions included in block 204 can be used to implement a step for applying a mixed granularity model on aggregated interaction data associated with a plurality of users of an online platform to generate extrapolated interaction data for each user in the plurality of users, the aggregated interaction data comprising a total number of occurrences of a target action performed by the plurality of users with respect to the online platform and the extrapolated interaction data comprising a series of actions leading to the target action for the user.

At block 206, the process 200 involves identifying an action impact 110 of each action 120 in the series of actions for each user 134 leading to the target action 122 based, at least in part, upon the extrapolating the series of actions associated with the user 134. The action impact 110 of an action 120 can describe a weight or degree of effect of the action 120 with respect to leading to the target action 122. In one example, the action impact 110 of an action 120 can be measured by a difference between a likelihood of the user 134 performing the target action with and without the action (counterfactual case). The likelihood of the user 134 performing the target action 122 can correspond to a level of engagement associated with the user 134. In some embodiments, an attribution model 108 is used to identify the impact 110 of each action 120. For instance, the attribution model 108 may be a machine-learning model trained using training data that includes relationships between an action 120 and a likelihood of the action 120 resulting in the target action 122. The training data of the attribution model 108 can be updated over time such that the attribution model 108 can continue to learn from the updated training data and improve its accuracy with respect to predicting the action impact 110 of each action 120. Functions included in block 206 can be utilized to implement a step for identifying impacts of individual actions in the series of actions on leading to the target action based, at least in part, upon the extrapolated interaction data.

At block 208, the process 200 involves causing user interfaces presented on the online platform 114 to be modified based on at least the identified action impacts 110. For instance, the online experience evaluation system 102 can provide the identified action impacts 110 to one or more computing systems (e.g., the host system 112) that are used to host or configure the online platform 114. The online experience evaluation system 102 may transmit the identified action impacts 110 to the computing systems via a local area network, a wide area network, or some combination thereof.

Once the computing systems receive the identified action impacts 110, the computing systems may use the identified action impacts 110 to customize the user interfaces or enhance an experience of certain users. Examples of adjusting the user interfaces can include modifying interface elements on the user interfaces (e.g., webpages), the order of presenting the user interfaces, or other aspects of the online platform 114. In one example, an interface element may include, but is not limited to, visual content, such as colors and layout, available click actions in certain click states, and design features, such as menus, search functions, and other elements. In some embodiments, the user interfaces may be modified in a manner that increases the likelihood of the user increasing engagement with the online platform 114. For instance, these adjustments to the user interfaces can correspond to performance-based modifications that can increase user engagement with the online platform 114. As an illustrative example, if a webpage of the online platform 114 displays products on sale for purchase, the host system 112 can cause the online platform 114 to increase a discount on the products displayed on the webpage so as to increase a likelihood of the user 134 performing a target action 122 of making a purchase.

FIG. 5 depicts an example of process 500 for applying a mixed granularity model 104 to generate extrapolated interaction data 132 using aggregated interaction data 116 as an input, according to certain embodiments of the present disclosure. The process 500 can be utilized to implement block 204 of FIG. 2. One or more computing devices (e.g., the online experience evaluation system 102) implement operations depicted in FIG. 5 by executing suitable program code. For illustrative purposes, the process 500 is described with reference to certain examples depicted in the figures. Other implementations, however, are possible.

At block 502, the process 500 involves determining whether a user 134 performed the target action 122. Specifically, the process 500 involves determining, based on an identifier of a user 134, whether the user 134 has performed at least one occurrence of the target action 122. If so, the process 500 involves proceeding to block 504 to assign a terminal action to the user based on a set of distributed occurrences determined using the aggregated interaction data. If the user 134 has not performed the target action 122, the process 500 involves proceeding to block 508 to generate a series of actions associated with the user 134. In some implementations, the user 134 may perform one or more actions that do not lead to or result in the target action. For instance, the user 134 may select one or more settings of a software program using a setup or installation wizard but ultimately decide to cancel an installation of the software program. The series of actions can be generated by assigning one or more actions to the user 134 based on a probability of the user performing at least one action of the one or more actions. As an illustrative example, knowing a total number of actions of 100 actions and a total number of users 134 being 1000 people, each user 134 can be assigned a 10% likelihood of performing an action.

At block 504, the process 500 involves assigning the terminal action based on the set of distributed occurrences determined using the aggregated interaction data (e.g., determined using Equation 2 described above). In some embodiments, the terminal action can be assigned to the identifier of the user 134. The terminal action can be performed by the user 134 prior to an occurrence of the target action such that the terminal action can be attributed to leading to or causing the occurrence of the target action.

At block 506, the process 500 involves generating the series of actions of the extrapolated interaction data 132 by assigning one or more additional actions based on the terminal action. The additional actions can be performed by the user 134 prior to the terminal action in the series of actions. As described above with respect to Equation 8, wᵢ represents a likelihood of the terminal action being associated with an additional action that is not a terminal action. For instance, a terminal action of clicking on a checkout interface element to initiate a transaction may have a 75% likelihood of being associated with an additional action of selecting a product to be purchased. Selecting the product occurs prior to initiating a virtual checkout process to purchase the product such that selecting the product is an action in the series of actions that leads to the target action of purchasing the product.

At block 510, the process 500 involves providing the series of actions as input to an attribution model 108 used to determine an impact 110 of each action 120 of the series of actions. The series of actions may be generated at block 506 or at block 508. In some embodiments, the attribution model 108 uses the series of actions generated at block 506 and at block 508 as input to determine the impact 110 of each action 120. For instance, the attribution model 108 may compare a first series of actions generated at block 506 to a second series of actions generated at block 508 with respect to a distribution of a total number of the actions 120. The attribution model 108 then can determine the impact 110 of each action 120 on resulting in the target action 122 being performed. For instance, if an action 120 is solely associated with the first series of actions, the action 120 can be assigned a relatively high impact score. As an example, submitting an email address to receive a communication may only occur when subscribing to the communication and not when a user 134 does not end up subscribing to the communication. Accordingly, the action 120 of submitting the email address may have a relatively high impact score with respect to the target action 122 of subscribing to the communication.

### Example of a Computing System for Implementing Certain Embodiments

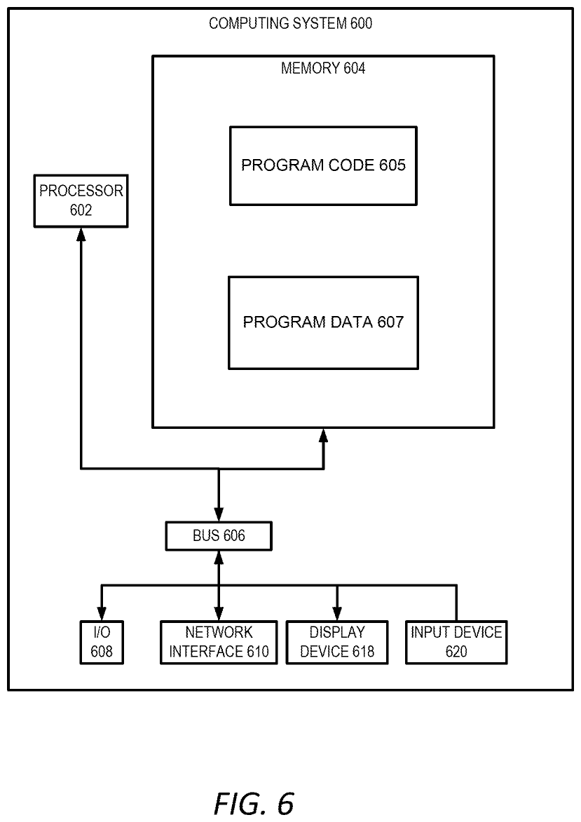

Any suitable computing system or group of computing systems can be used for performing the operations described herein. For example, FIG. 6 depicts an example of the computing system 600. The implementation of computing system 600 could be used for one or more of an online experience evaluation system 102 and a host system 112. In other embodiments, a single computing system 600 having devices similar to those depicted in FIG. 6 (e.g., a processor, a memory, etc.) combines the one or more operations and data stores depicted as separate systems in FIG. 1.

The depicted example of a computing system 600 includes a processor 602 communicatively coupled to one or more memory devices 604. The processor 602 executes computer-executable program code stored in a memory device 604, accesses information stored in the memory device 604, or both. Examples of the processor 602 include a microprocessor, an application-specific integrated circuit (“ASIC”), a field-programmable gate array (“FPGA”), or any other suitable processing device. The processor 602 can include any number of processing devices, including a single processing device.

A memory device 604 includes any suitable non-transitory computer-readable medium for storing program code 605, program data 607, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 600 may also include a number of external or internal devices, an input device 620, a presentation device 618, or other input or output devices. An I/O interface 608 can receive input from input devices or provide output to output devices. One or more buses 606 are also included in the computing system 600. The bus 606 communicatively couples one or more components of a respective one of the computing system 600.

The computing system 600 executes program code 605 that configures the processor 602 to perform one or more of the operations described herein. Examples of the program code 605 include, in various embodiments, modeling algorithms executed by the online experience evaluation system 102 (e.g., functions of the mixed granularity model 104 or attribution model 108), the online platform 114, or other suitable applications that perform one or more operations described herein (e.g., one or more development applications for configuring the online platform 114). The program code may be resident in the memory device 604 or any suitable computer-readable medium and may be executed by the processor 602 or any other suitable processor.

In some embodiments, one or more memory devices 604 stores program data 607 that includes one or more datasets or data attributes, and models described herein. Examples of these datasets or data attributes, include aggregated interaction data, individual-level interaction data, experience metrics, training interaction data or historical interaction data, transition importance data, etc. In some embodiments, one or more of datasets, data attributes, models, and functions are stored in the same memory device (e.g., one of the memory devices 604). In additional or alternative embodiments, one or more of the programs, data sets, models, and functions described herein are stored in different memory devices 604 accessible via a data network.

In some embodiments, the computing system 600 also includes a network interface device 610. The network interface device 610 includes any device or group of devices suitable for establishing a wired or wireless data connection to one or more data networks. Non-limiting examples of the network interface device 610 include an Ethernet network adapter, a modem, and/or the like. The computing system 600 is able to communicate with one or more other computing devices (e.g., a computing device executing an online experience evaluation system 102) via a data network using the network interface device 610.

In some embodiments, the computing system 600 also includes the input device 620 and the presentation device 618 depicted in FIG. 6. An input device 620 can include any device or group of devices suitable for receiving visual, auditory, or other suitable input that controls or affects the operations of the processor 602. Non-limiting examples of the input device 620 include a touchscreen, a mouse, a keyboard, a microphone, a separate mobile computing device, etc. A presentation device 618 can include any device or group of devices suitable for providing visual, auditory, or other suitable sensory output. Non-limiting examples of the presentation device 618 include a touchscreen, a monitor, a speaker, a separate mobile computing device, etc.

Although FIG. 6 depicts the input device 620 and the presentation device 618 as being local to the computing device that executes the online experience evaluation system 102, other implementations are possible. For instance, in some embodiments, one or more of the input device 620 and the presentation device 618 can include a remote client-computing device that communicates with the computing system 600 via the network interface device 610 using one or more data networks described herein.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for causing an interactive computing environment hosted by an online platform to be modified, where the computer-implemented method causes one or more processing devices to perform operations comprising:
obtaining, by an impact identification system, aggregated interaction data associated with a plurality of users of the online platform, the aggregated interaction data comprising a total number of occurrences of a target action performed by the plurality of users with respect to the online platform;
extrapolating, by the impact identification system, the aggregated interaction data by applying a mixed granularity model to generate extrapolated interaction data for each user in the plurality of users, the extrapolated interaction data comprising a series of actions leading to the target action for the user;
identifying, by the impact identification system, an impact of each action in the series of actions for each user on leading to the target action based, at least in part, upon the extrapolating the series of actions associated with the user; and
causing, by the impact identification system, user interfaces presented on the online platform to be modified based on at least the identified impacts.

2. The method of claim 1, wherein identifying the impact of each action in the series of actions for each user on leading to the target action is performed using an attribution model configured to accept the series of actions as input.

3. The method of claim 1, wherein the total number of occurrences of the target action performed by the plurality of users in the aggregated interaction data is associated with a time period, and wherein extrapolating the aggregated interaction data further comprises distributing the total number of occurrences of the target action over the time period.

4. The method of claim 3, wherein distributing the total number of occurrences of the target action over the time period further comprises:
dividing the time period into one or more time points;
distributing the total number of occurrences across the one or more time points to generate a set of distributed occurrences; and
providing the set of distributed occurrences to the mixed granularity model as input to extrapolate the aggregated interaction data.

5. The method of claim 1, wherein extrapolating the aggregated interaction data by applying the mixed granularity model comprises:
determining, based on an identifier of a user of the plurality of users, that the user has performed at least one occurrence of the target action;
assigning a terminal action based on a set of distributed occurrences determined using the aggregated interaction data, wherein the terminal action is performed prior to an occurrence of the target action; and
in response to assigning the terminal action, generating the series of actions of the extrapolated interaction data by assigning one or more additional actions based on the terminal action, wherein the one or more additional actions are performed by the user prior to the terminal action in the series of actions.

6. The method of claim 1, wherein extrapolating the aggregated interaction data by applying the mixed granularity model comprises:
determining, based on an identifier of a user of the plurality of users, that the user has not performed the target action; and
generating the series of actions corresponding to the user by assigning one or more actions performed by the plurality of users to the series of actions of the user based on a probability of the user performing at least one action of the one or more actions.

7. The method of claim 1, wherein extrapolating the aggregated interaction data further comprises:
pre-processing the aggregated interaction data to generate a total number of actions performed by the plurality of users, wherein each action of the total number of actions is assigned to a respective user of the plurality of users by applying the mixed granularity model to generate the series of actions for each user.

8. A system comprising:
a host system configured for:
hosting an online platform configured for presenting user interfaces to users, and
modifying the user interfaces presented to a user through the online platform based, at least in part, on impacts of individual actions on leading to a target action performed on the online platform; and
an online experience evaluation system comprising:
one or more processing devices configured for performing operations comprising:
applying a mixed granularity model on aggregated interaction data associated with a plurality of users of the online platform to generate extrapolated interaction data for each user in the plurality of users, the aggregated interaction data comprising a total number of occurrences of the target action performed by the plurality of users with respect to the online platform and the extrapolated interaction data comprising a series of actions leading to the target action for the user, and
identifying an impact of each action in the series of actions for each user on leading to the target action based, at least in part, upon the series of actions in the extrapolated interaction data; and
a network interface device configured for transmitting, to the online platform, the identified impact of each action in the series of actions for each user on leading to the target action.

9. The system of claim 8, wherein identifying the impact of each action in the series of actions for each user on leading to the target action is performed using an attribution model configured to accept the series of actions as input.

10. The system of claim 8, wherein the total number of occurrences of the target action performed by the plurality of users in the aggregated interaction data is associated with a time period, and wherein extrapolating the aggregated interaction data further comprises distributing the total number of occurrences of the target action over the time period.

11. The system of claim 10, wherein distributing the total number of occurrences of the target action over the time period further comprises:
dividing the time period into one or more time points;
distributing the total number of occurrences across the one or more time points to generate a set of distributed occurrences; and
providing the set of distributed occurrences to the mixed granularity model as input to extrapolate the aggregated interaction data.

12. The system of claim 8, wherein extrapolating the aggregated interaction data by applying the mixed granularity model comprises:
determining, based on an identifier of a user of the plurality of users, that the user has performed at least one occurrence of the target action;
assigning a terminal action based on a set of distributed occurrences determined using the aggregated interaction data, wherein the terminal action is performed prior to an occurrence of the target action; and
in response to assigning the terminal action, generating the series of actions of the extrapolated interaction data by assigning one or more additional actions based on the terminal action, wherein the one or more additional actions are performed by the user prior to the terminal action in the series of actions.

13. The system of claim 8, wherein extrapolating the aggregated interaction data by applying the mixed granularity model comprises:
determining, based on an identifier of a user of the plurality of users, that the user has not performed the target action; and
generating the series of actions corresponding to the user by assigning one or more actions performed by the plurality of users to the series of actions of the user based on a probability of the user performing at least one action of the one or more actions.

14. The system of claim 8, wherein extrapolating the aggregated interaction data further comprises:
pre-processing the aggregated interaction data to generate a total number of actions performed by the plurality of users, wherein each action of the total number of actions is assigned to a respective user of the plurality of users by applying the mixed granularity model to generate the series of actions for each user.

15. A non-transitory computer-readable medium having program code that is stored thereon, the program code executable by one or more processing devices for performing operations comprising:
a step for applying a mixed granularity model on aggregated interaction data associated with a plurality of users of an online platform to generate extrapolated interaction data for each user in the plurality of users, the aggregated interaction data comprising a total number of occurrences of a target action performed by the plurality of users with respect to the online platform and the extrapolated interaction data comprising a series of actions leading to the target action for the user;
a step for identifying impacts of individual actions in the series of actions on leading to the target action based, at least in part, upon the extrapolated interaction data; and
causing the identified impacts to be accessible by the online platform, wherein the identified impacts are usable for changing user interfaces presented on the online platform.

16. The non-transitory computer-readable medium of claim 15, wherein identifying the impact of each action in the series of actions for each user on leading to the target action is performed using an attribution model configured to accept the series of actions as input.

17. The non-transitory computer-readable medium of claim 15, wherein the total number of occurrences of the target action performed by the plurality of users in the aggregated interaction data is associated with a time period, and wherein extrapolating the aggregated interaction data further comprises distributing the total number of occurrences of the target action over the time period.

18. The non-transitory computer-readable medium of claim 17, wherein distributing the total number of occurrences of the target action over the time period further comprises:
dividing the time period into one or more time points;
distributing the total number of occurrences across the one or more time points to generate a set of distributed occurrences; and
providing the set of distributed occurrences to the mixed granularity model as input to extrapolate the aggregated interaction data.

19. The non-transitory computer-readable medium of claim 15, wherein extrapolating the aggregated interaction data by applying the mixed granularity model comprises:
determining, based on an identifier of a user of the plurality of users, that the user has performed at least one occurrence of the target action;
assigning a terminal action based on a set of distributed occurrences determined using the aggregated interaction data, wherein the terminal action is performed prior to an occurrence of the target action; and
in response to assigning the terminal action, generating the series of actions of the extrapolated interaction data by assigning one or more additional actions based on the terminal action, wherein the one or more additional actions are performed by the user prior to the terminal action in the series of actions.

20. The non-transitory computer-readable medium of claim 15, wherein extrapolating the aggregated interaction data by applying the mixed granularity model comprises:
determining, based on an identifier of a user of the plurality of users, that the user has not performed the target action; and
generating the series of actions corresponding to the user by assigning one or more actions performed by the plurality of users to the series of actions of the user based on a probability of the user performing at least one action of the one or more actions.
